(19) United States
(12) Patent Application Publication
(10) Pub. No.: US 2013/0060998 A1
(43) Pub. Date: Mar. 7, 2013

(54) CONTROL SYSTEM AND METHOD OF DISK ARRAY

(71) Applicant: Don-Yun LIU, New Taipei City (TW)

(72) Inventor: Don-Yun LIU, New Taipei City (TW)

(73) Assignee: QSAN Technology, Inc., Taipei (TW)

(21) Appl. No.: 13/604,107

(22) Filed: Sep. 5, 2012

(30) Foreign Application Priority Data
Sep. 7, 2011 (TW) 100132296

(51) Int. Cl. G06F 12/00

(52) U.S. Cl. 711/114; 711/200

(57) ABSTRACT

A control system of a disk array including multiple data storage disks is provided. The control system includes a front-end circuit, a central processing unit and a back-end circuit. The front-end circuit is for receiving multiple packets corresponding to a first protocol from a network. The central processing unit has multiple cores. One of the cores is configured as a first dedicated core to interpret the packets corresponding to the first protocol into multiple first commands. The other non-dedicated cores are for processing the first commands and outputting multiple first access instructions. The back-end circuit is for translating the first access instructions to access the data storage disks.

This application claims the benefit of Taiwan application Serial No. 100132296, filed Sep. 7, 2011, the subject matter of which is incorporated herein by reference.

### BACKGROUND

1. Technical Field of the Disclosure

The disclosure relates in general to a control system and method of a disk array.

2. Description of the Related Art

For business users, disk array has become a commonly used device for storing a large volume of data. The existing disk array system normally uses a front-end chip to interpret the packets corresponding to various protocols that are received from a network. As new protocols are provided, new front-end chips must be used to replace existing front-end chips in order to interpret the packets corresponding to new protocols.

Consequently, the cost for the hardware of the disk array system cannot be reduced, and the disk array system is lacking of adaptability.

### SUMMARY OF THE DISCLOSURE

The disclosure is directed to a control system and method of a disk array. Dedicated cores of multiple cores of a central processing unit are used for interpreting packets corresponding to specific protocols, so as to save the hardware cost.

According to a first aspect of the present disclosure, a control system of a disk array including multiple data storage disks is provided. The control system includes a front-end circuit, a central processing unit and a back-end circuit. The front-end circuit is for receiving multiple packets corresponding to a first protocol from a network. The central processing unit has multiple cores. One of the cores is configured as a first dedicated core to interpret the packets corresponding to the first protocol into multiple first commands. The other non-dedicated cores are for processing the first commands and outputting multiple first access instructions. The back-end circuit is for translating the first access instructions to access the data storage disks.

According to a second aspect of the present disclosure, a control method of a disk array is provided. The method includes steps. A front-end circuit is used for receiving multiple packets corresponding to a first protocol from a network. One of the cores of a central processing unit is configured as a first dedicated core to interpret the packets corresponding to the first protocol into multiple first commands. The other non-dedicated cores are used for processing the first commands and outputting multiple first access instructions. A back-end circuit is used for translating the first access instructions to access multiple data storage disks of the disk array.

The above and other contents of the disclosure will become better understood with regard to the following detailed description of the preferred but non-limiting embodiment. The following description is made with reference to the accompanying drawings.

### BRIEF DESCRIPTION OF THE DRAWINGS

FIG. 1 shows a control system of a disk array according to an embodiment; and

FIG. 2 shows a flowchart of a control method of a disk array according to an embodiment.

### DETAILED DESCRIPTION OF THE DISCLOSURE

The disclosure provides a control system and method of a disk array. By configuring one of the cores of a central processing unit as a dedicated core, packets corresponding to a specific protocol may be interpreted without using new front-end chips, hence saving hardware cost.

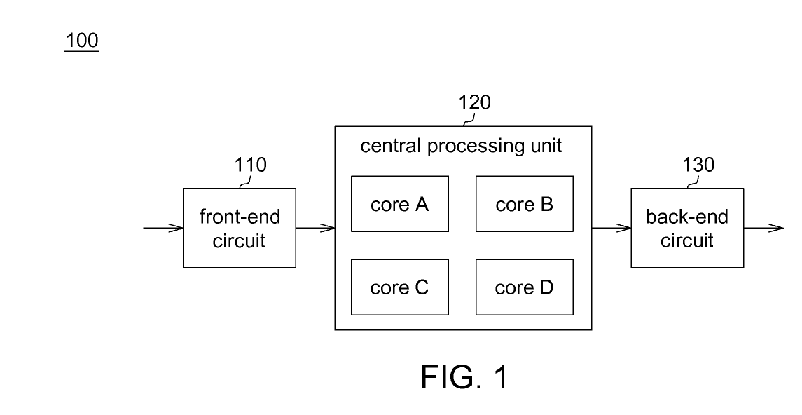

Referring to FIG. 1, a control system of a disk array according to an embodiment is shown. The control system 100 of FIG. 1 is for accessing data of a disk array including multiple data storage disks. The control system 100 includes a front-end circuit 110, a central processing unit 120 and a back-end circuit 130. The front-end circuit 110 is for receiving multiple packets corresponding to a first protocol from a network. The first protocol is such as a fiber channel on Ethernet (FCoE) protocol, and the corresponding network is a local area network (LAN), but the disclosure is not limited thereto. In the present embodiment, the front-end circuit 110 does not process the packets corresponding to the first protocol. The front-end circuit 110 may be realized by a network card or a front-end chip having older specification and being incapable of processing the first protocol.

The central processing unit 120 has multiple cores. In the present embodiment, the central processing unit 120 has cores A˜D, but the disclosure is not limited thereto. One of the cores A˜D, such as core A, may be configured as a first dedicated core and dedicated for the application programming interface (API) corresponding to the first protocol to interpret the packets corresponding to the first protocol into multiple first commands. Given that the cores B˜D are not configured as dedicated cores, the cores B˜D receive and process the first commands, and then output multiple corresponding first access instructions. That is, the non-dedicated cores B˜D are for processing various operations related to the disk array. The back-end circuit 130, such as a chip, is for translating the first access instructions to access multiple data storage disks of the disk array.

Furthermore, multiple cores may be configured as dedicated cores for processing packets corresponding to respective protocols. For example, the front-end circuit 110 is for receiving multiple packets corresponding to a second protocol from a network. The second protocol is such as an Internet small computer system interface (iSCSI) protocol, and the corresponding network is Internet. However, the disclosure is not limited thereto, and the second protocol may also be realized as a local area network small computer system interface (HyperSCSI) protocol or other known protocols. Similarly, in the present embodiment, the front-end circuit 110 does not process the packets corresponding to the first protocol.

Another core of the central processing unit 120, such as core B, may be configured as a second dedicated core and dedicated for the application programming interface (API) corresponding to the second protocol to interpret the packets corresponding to the second protocol into multiple second commands. Given that the C˜D are not configured as dedicated cores, the cores C˜D receive and process the first commands and the second commands, and then output multiple corresponding first and second access instructions. That is, the non-dedicated cores C˜D are for processing various operations related to the disk array. In the present embodiment, the back-end circuit 130 translates the first and the second access instructions to access multiple data storage disks of the disk array.

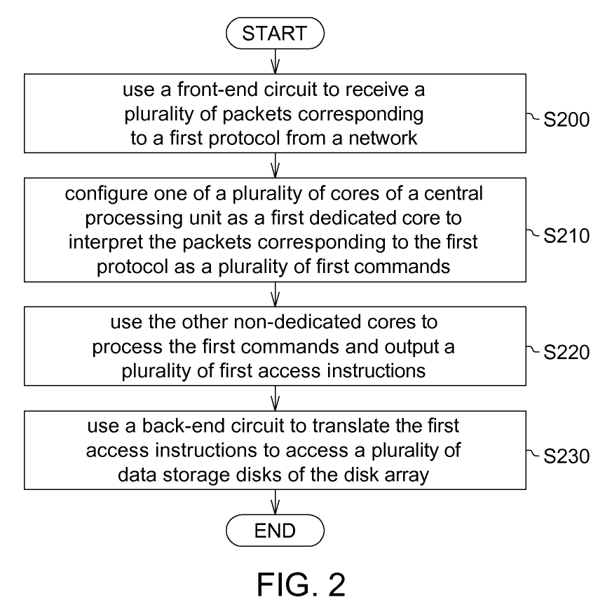

The disclosure further provides a control method of a disk array. Referring to FIG. 2, a flowchart of a control method of a disk array according to an embodiment is shown. In step S200, a front-end circuit is used for receiving multiple packets corresponding to a first protocol from a network. In step S210, one of the cores of a central processing unit is configured as a first dedicated core to interpret the packets corresponding to the first protocol into multiple first commands. In step S220, other non-dedicated cores are used for processing the first commands and outputting multiple first access instructions. In step S230, a back-end circuit is used for translating the first access instructions to access multiple data storage disks of the disk array.

The principles of the control method of a disk array are already disclosed in the control system of a disk array 100 and related disclosure, and are not repeated here.

According to the control system and method of disk array disclosed in above embodiments of the disclosure, one of the cores of a central processing unit is configured as a dedicated core. The dedicated core is capable of interpreting the packets corresponding to a specific protocol without using new front-end chips, hence saving the hardware cost.

While the disclosure has been described by way of example and in terms of the preferred embodiments, it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A control system of a disk array comprising a plurality of data storage disks, wherein the control system comprises:
a front-end circuit for receiving a plurality of packets corresponding to a first protocol from a network;
a central processing unit having a plurality of cores, wherein one of the cores is configured as a first dedicated core to interpret the packets corresponding to the first protocol as a plurality of first commands, and the other non-dedicated cores are for processing the first commands and outputting a plurality of first access instructions; and
a back-end circuit for translating the first access instructions to access the data storage disks.

2. The control system of a disk array according to claim 1, wherein the first protocol is a fiber channel on Ethernet (FCoE) protocol.

3. The control system of a disk array according to claim 1, wherein the front-end circuit is for receiving a plurality of packets corresponding to a second protocol from the network, another one of the cores is configured as a second dedicated core to interpret the packets corresponding to the second protocol as a plurality of second commands, the other non-dedicated cores are for processing the second commands and outputting a plurality of second access instructions, and the back-end circuit is for translating the second access instructions to access the data storage disks.

4. The control system of a disk array according to claim 3, wherein the first protocol is a fiber channel on Ethernet (FCoE) protocol, and the second protocol is an Internet small computer system interface (iSCSI) protocol.

5. A control method of a disk array, wherein the method comprises:
using a front-end circuit to receive a plurality of packets corresponding to a first protocol from a network;
configuring one of a plurality of cores of a central processing unit as a first dedicated core to interpret the packets corresponding to the first protocol as a plurality of first commands;
using the other non-dedicated cores to process the first commands and output a plurality of first access instructions; and
using a back-end circuit to translate the first access instructions to access a plurality of data storage disks of the disk array.

6. The control method of a disk array according to claim 5, wherein the first protocol is an FCoE protocol.

7. The control method of a disk array according to claim 5, wherein the method further comprises:
using the front-end circuit to receive a plurality of packets corresponding to a second protocol from the network;
configuring another one of the cores as a second dedicated core to interpret the packets corresponding to the second protocol as a plurality of second commands;
using the other non-dedicated cores to process the second commands and output a plurality of second access instructions; and
using the back-end circuit to translate the second access instructions to access the data storage disks.

8. The control method of a disk array according to claim 7, wherein the first protocol is an FCoE protocol, and the second protocol is an iSCSI protocol.
